(19) United States
(12) Patent Application Publication
(10) Pub. No.: US 2005/0195747 A1
(43) Pub. Date: Sep. 8, 2005

(54) System and methods for creating representational networks

(76) Inventors: Jeffrey Stamps, West Newton, MA (US); Jessica Lipnack, West Newton, MA (US)

Correspondence Address: FOLEY HOAG, LLP;PATENT GROUP, WORLD TRADE CENTER WEST, 155 SEAPORT BLVD, BOSTON, MA, 02110, US

(21) Appl. No.: 11/068,485

(22) Filed: Feb. 28, 2005

Related U.S. Application Data
(60) Provisional application No. 60/548,259, filed on Feb. 27, 2004.

(51) Int. Cl. H04L 1/00

(52) U.S. Cl. 370/241

(57) ABSTRACT

Methods and systems described herein may represent organizations as a network, where the network nodes and links may be displayed, analyzed, and structured. The network nodes may represent positions within an organization, with network links established based on reporting relationships between such positions in the organization. A position may be filled by a person/entity, may stand for an organizational unit, may represent a leadership team, and/or may be associated with a location. In addition to position, other node types may include organizational unit, person, group, and/or place. Organization networks structured by these node types may thus have associated node modes, as in the position example. Other node types may also be used in the representation of organization. The network representation may provide network metrics for the organization, including level (the path length, or number of links, to the root node), size (the number of nodes), and span (the number of reporting relationships to each node).

### RELATED APPLICATIONS

This application claims priority to, and incorporates by reference, the entire disclosure of U.S. Provisional Patent Application No. 60/548,259, filed on Feb. 27, 2004.

### BACKGROUND

(1) Field

The disclosed methods and systems relate generally to representing organizational structures and processes as networks, and more particularly to using networks for organizational visualization and for measuring organizational characteristics.

(2) Description of Relevant Art

Many organizations are organized and/or visualized using a ladder structure that includes a managing entity at the top, and entities reporting to such managing entity visually and/or pictorially below the managing entity. A large organization often refers to these diagrams as organization charts, and the organization charts can be developed with different levels of granularity, based on the size of the organization, and the size of the paper on which the organization chart (“org chart”) is presented. Often, different levels of granularity are presented across multiple org charts, and it thus can be difficult to consolidate the information amongst multiple org charts. In addition, it may be difficult to capture relationships within the organization other than “vertical” ones.

### SUMMARY

One embodiment of the disclosed methods and systems represents organizations as a network, where the network nodes and links can be displayed, analyzed, and structured (such as in an online collaboration system). As an example, in one embodiment the network nodes may represent positions within an organization, with network links established based on reporting relationships between such positions (e.g., nodes) in the organization. In representing positions as nodes in this embodiment, it should be recognized that a variety of types of information may be represented as a positional node. A position may represent an organizational unit and may be filled by a person or entity, or a position may represent a leadership team, or a position may be associated with a location and/or objects, depending on the structure portrayed and/or the representation desired.

Accordingly, in this embodiment, such positions or nodes may be represented in one or more different ways, including, for example, as the organizational unit associated with the position, the person(s) associated with the position (e.g., manager), a group associated with the position, a physical location (e.g., building, mail stop, city, state, country, zip code, and/or other physical and/or geographical identifier) and/or a computer-based location. Other associations also are possible. In other embodiments, other node types are contemplated, and may include things (e.g., physical assets), tasks, information objects, and/or identifiers associated with a position in an organization. Based on the embodiment and/or the desired application, these different representation node “modes” may be displayed one or more at a time. As suggested above, in addition to position, other organization node types may include organizational unit, person, group, object and/or place. Organization networks structured by these node types may have associated node modes. Other node types may also be used in the representation of the organization. For example, position nodes and group nodes may be related as a single bipartite network.

In some embodiments, the nodes may be further associated with additional information and/or objects that may be accessed by selecting (e.g., “clicking-on”, cursor hover, etc.) one or more nodes. Such additional information and/or object may include, for example, a text document, an image, a hyperlink (e.g., URL), an executable file (e.g., applet), external content (e.g., content other than the links and nodes), and/or other processor executable instructions for providing and/or displaying information, where the aforementioned “additional information” may be referred to herein collectively as a node object. In some embodiments, the node object associated with a selected node may be based on the node mode such that as the node mode changes, the associated node object for the selected node may also change. Such changing of node objects may occur for one or more of the nodes. In some embodiments, node objects associated with all nodes may be displayed substantially simultaneously, and/or such information/objects may be displayed for selected nodes.

In some embodiments, links between the nodes may be of one or more different categories and/or types, and accordingly, links can represent a “reporting” relationship between the positions/nodes, a “functional” or process relationship between the positions/nodes, a group membership between the positions/nodes, an informational sender-receiver connection between the positions/nodes, and/or a personal relationship between the positions/nodes, amongst others. Those of ordinary skill will recognize that the links between nodes may include other relationships between positions/nodes of an organization. The disclosed methods and systems may allow for a user selection of node mode, and also, of link type or types. One selection may include showing all link types, while another selection may include hiding some or all link types to allow for visualization of nodes only. One or more links of one or more link types may be associated with a given pair of nodes. Although in one embodiment, link type is generally the same regardless of node mode, in some embodiments, link type may change based on node mode.

The disclosed methods and systems, in some embodiments, may allow for color-coding schemes and/or other type identifications to be applied to the nodes and/or node links. In one embodiment, for example, nodes may be color coded based on level in the organization, performance ratings, profitability/non-profitability associated with a node/position, compensation associated with the node/position, and/or other data associated with a node/position.

Similarly, different visual representations of different link types may be provided by the disclosed methods and systems. For example, some embodiments may use solid lines to represent reporting-type links as a fundamental relationship of an organization and dotted lines to represent matrix relationships, such as between human resources and payroll positions. In addition or alternately, links may be represented singularly or in accumulating layers.

The data for generating, building, and/or creating the network, including the nodes and/or links, may be manually entered and/or derived from a database (e.g., query) and/or interactively constructed from online objects and relationships, as in a computer-based collaboration system.

The output from embodiments relating to the above and other representations may be used to drive a variety of computer-based technologies, including: a visual display of the network, with content pointers and an online editing capability, an analytic engine that creates various relationship and attribute calculations and generates node and network metrics, and a “virtual workplace design” engine that translates the network into the architecture of an online workspace, feeding back changes to one or more databases that include the associations of nodes/node identifiers, links, and object information.

In some embodiments, the taxonomy of nodes and links may serve as a category system for managing unstructured organizational knowledge, and provide a navigation system to that knowledge. Such network representation may serve as a front-end to and integrator of organizational knowledge management systems.

In some embodiments, methods and systems may be used in a simulation mode to test the effect of adding and deleting nodes and links, and of whole designs.

The disclosed methods and systems can provide a framework for both inter- and intra-organizational network modeling, comparisons, and benchmarking.

In some embodiments, the methods and systems may provide useful metrics that may be used to analyze the structure of the organization. Nodes having more than the average number of links, referred to herein as hubs, may be identified, which may form the basis for designing effective communication strategies for the organization. It should be recognized that applying network theory to a network representation of an organization may provide a variety of metrics.

In some embodiments, a level metric may indicate the path length or number of links between a chosen, or “root” node and other nodes in the network. In some embodiments, a size metric may indicate the number of nodes in the organization or network. In some embodiments, a span (degree) metric may indicate the numbers of different types of links to and from a node. In some embodiments, other metrics may include measures indicating the pattern of distribution of hubs (degree exponent) in the network, measures indicating limitations that may be imposed on span, or measures indicating a likelihood that positions linked to a node are themselves linked (clustering). Other network measures may also be applied.

Other objects and advantages will become apparent hereinafter in view of the specification and drawings.

In one embodiment, a method of generating a plurality of representations of a structure for at least a portion of an organization can include assigning a plurality of positions in the organization to nodes, each position being assigned to a separate node, defining a plurality of characteristics, each characteristic being associated with at least some positions in the organization, and having a defined value at each such associated position, assigning each of a plurality of modes to a characteristic associated with at least some positions in the organization, establishing a plurality of links, each link being connected to two of the nodes based on a relationship between the positions assigned to the two nodes in at least one mode, and generating the plurality of representations, each generated representation being associated with a selected mode. Each generated representation can include a display of a network constituting a plurality of the nodes, and a plurality of the links, with each displayed node being displayed according to the value of the characteristic to which the selected mode is assigned, the value being the value of the characteristic for the position assigned to the displayed node, and each displayed link being displayed connected to two of the displayed nodes based on the relationship between the positions assigned to the displayed nodes in the selected mode.

In some aspects, the method can include differentiating the displayed links based on type of relationship and choosing one or more types of relationship for display, including a direct reporting relationship, a matrix reporting relationship, a group membership relationship, a functional relationship, and/or a personal relationship. The method can include determining metrics for the organization based on network theory analysis of the network constituting the plurality of the nodes, and the plurality of the links.

An average number of links per node can be determined and hubs in the network can be identified, a hub being a node having a number of links greater than the average number of links. The average number of links can be determined by determining the number of direct reporting relationship links to each node, determining the number matrix reporting relationship links to each node, adding the numbers and dividing by the total number of nodes in the network.

One metric can be determined by choosing a node as a root node, and determining an average number of links from other nodes to the root node. Another metric is determined by determining a number of nodes in a portion of the network corresponding to a component of the organization.

In one embodiment, computer-readable medium can contain instructions for controlling a computer system to generate a plurality of representations of a structure for at least a portion of an organization. The instructions can include instructions for assigning positions in the organization to nodes, each position being assigned to a separate node, defining a plurality of characteristics, each characteristic being associated with at least some positions in the organization, and having a defined value at each such associated position, assigning each of a plurality of modes to a characteristic associated with at least some positions in the organization, establishing a plurality of links, each link being connected to two of the nodes based on a relationship between the positions assigned to the two nodes in at least one mode, and generating the plurality of representations. Each generated representation can be associated with a selected mode, wherein each generated representation includes a display of a network constituting a plurality of the nodes, and a plurality of the links, with each displayed node being displayed according to the value of the characteristic to which the selected mode is assigned, the value being the value of the characteristic for the position assigned to the displayed node, and each displayed link being displayed connected to two of the displayed nodes based on the relationship between the positions assigned to the displayed nodes in the selected mode.

The computer-readable medium can include instructions for determining metrics for the organization based on network theory analysis of the network constituting the plurality of the nodes, and the plurality of the links. Further instructions can include differentiating the displayed links based on type of relationship, and choosing at least one type of relationship for display, including direct reporting relationships, matrix reporting relationships, group membership relationships, functional relationships, and personal relationships.

### BRIEF DESCRIPTION OF THE DRAWINGS

The following figures depict certain illustrative embodiments in which like reference numerals refer to like elements. These depicted embodiments are to be understood as illustrative and not as limiting in any way.

FIG. 1 is a schematic network representation of an exemplary organization;

FIG. 2 is a schematic network representation of the exemplary organization of FIG. 1 in a positional mode;

FIG. 3 is a schematic network representation of the exemplary organization of FIG. 1 in a person mode; and

FIG. 4 is a simplified schematic network representation of the exemplary organization of FIG. 1 in a group mode.

### DESCRIPTION

To provide an overall understanding, certain illustrative embodiments will now be described; however, it will be understood by one of ordinary skill in the art that the systems and methods described herein are only illustrative embodiments, and may be adapted and modified to provide systems and methods for other suitable applications, and that other additions and modifications may be made without departing from the scope of the systems and methods described herein.

Unless otherwise specified, the illustrated embodiments can be understood as providing exemplary features of varying detail of certain embodiments, and therefore, unless otherwise specified, features, components, modules, and/or aspects of the illustrations can be otherwise combined, separated, interchanged, and/or rearranged without departing from the disclosed systems or methods. Additionally, the shapes and sizes of components are also exemplary and unless otherwise specified, can be altered without affecting the scope of the disclosed and exemplary systems or methods of the present disclosure.

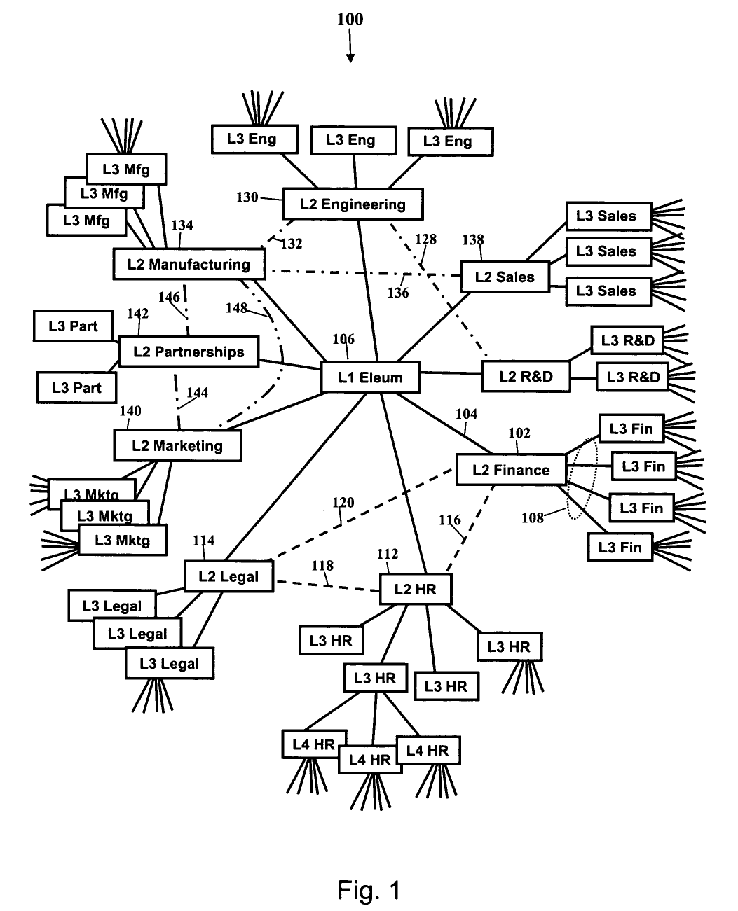

Referring to FIG. 1, a network representation 100 of an organization is illustrated. For purposes of explanation, a hypothetical organization, referred to herein as Eleum, forms the basis of the figures to be described. The Eleum organization includes approximately 5,000 employees in a hierarchical organization of generally seven levels, starting with the head of the organization, e.g., the CEO, designated as L1 and continuing to the lowest level L7. The levels correspond to reporting chains. For example, L2 organizational unit leaders can report upwards to level L1 while L3 department heads can report upwards to an L2 unit leader, etc.

The representation shown in FIG. 1 is based on a network visualization tool known in the art as a hyperbolic viewer. Such views can illustrate a network from different points of view, with connections past two or three levels of nodes, in the case of FIG. 1, from the central viewpoint, with the network generally being truncated thereafter. For representation 100, the central viewpoint is level L1, with level L3 generally forming the outer perimeter. If an L3 viewpoint were desired, the representation may include levels L1 and L5 at the periphery (two or three levels of nodes in either direction from the representative viewpoint level L3).

To obtain network representation 100 of the Eleum organization, data may be taken from Eleum's organizational chart. Typically, such charts may include hierarchical levels of boxes, each denoting a position, the person in the position and the organizational unit to which it belongs. Reporting chains or lines may link the boxes in one level to boxes in other levels. Using such a chart, each box may be designated as a node, and the reporting chain can be designated a link. Alternately and/or in addition, such node and link data may be obtained from an organizational database, such as may be available from an organization's information management systems, particularly personnel and/or organizational directory systems. The nodes and links may be input to the visualization tool, resulting in the network representation 100 of the Eleum organization. For representation 100, the nodes are shown with their organizational unit designation, e.g., node 102 is a level L2 Finance organizational unit. Link 104 indicates a reporting chain for node 102 to level L1 node 106, while links 108 indicate the plurality of level L3 Finance nodes reporting to node 102.

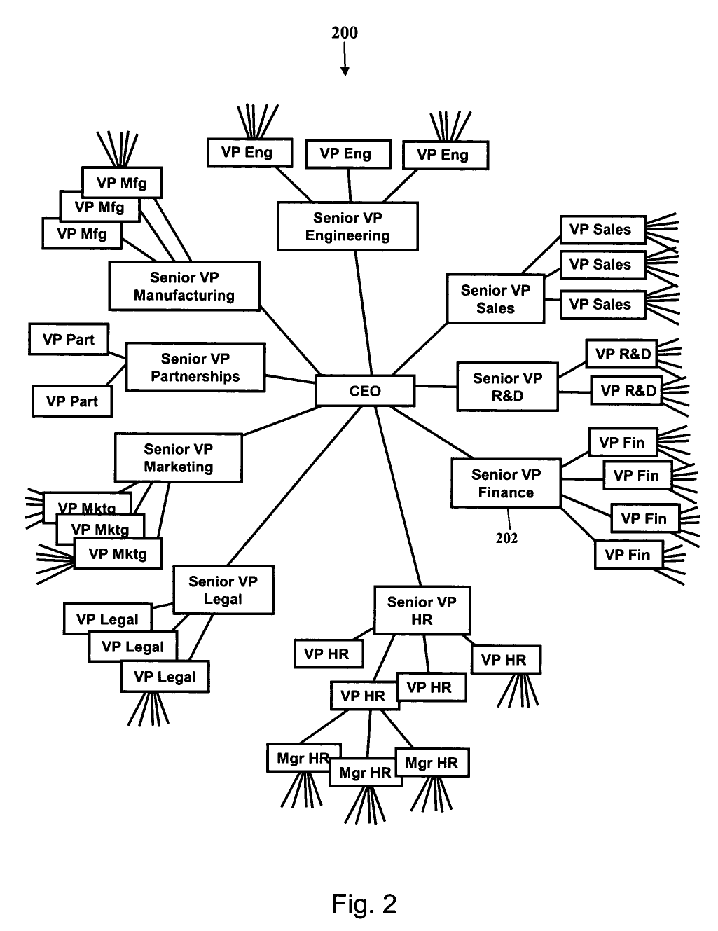

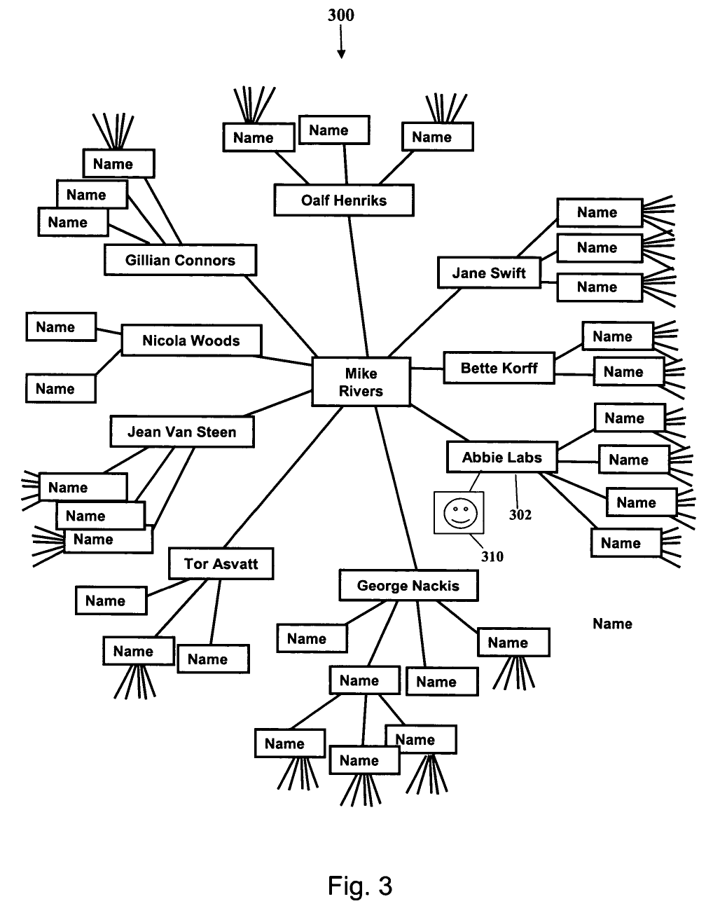

Based on the boxes in an organizational chart indicating person, position and organizational unit, it follows that the nodes may include different modes, a person or people mode, a positional mode and an organizational mode. FIGS. 2 and 3 illustrate network representations 200 and 300 of the Eleum organization with nodes designating positions and people in those positions, respectively. FIG. 3 further illustrates that a node may include additional information associated with the node, such as a picture of a person. For example, node 302 (corresponding to node 102 in FIG. 1) includes a thumbnail photo 310 of “Abbie Labs” who is the Senior VP of Accounting (reference numeral 202 in FIG. 2) at the L2 level of Finance (reference numeral 102 in FIG. 1). In one embodiment, such additional information and/or object may be interactive and may include, for example, a text document, an image, a hyperlink (e.g., URL), an executable file (e.g., applet), external content (e.g., content other than the links and nodes), and/or other processor executable instructions for providing and/or displaying information. For example, further information such a phone number, fax number, address, etc., may be obtained by selecting the thumbnail, e.g., by clicking on the thumbnail. Collectively, the aforementioned “additional information” may be referred to herein as node objects.

In addition to the people, unit and position designations, the organizational chart may indicate groupings of employees. For example, persons and/or positions may be part of teams, boards, committees, etc., having defined roles within the organization. The links between members of the groups and between groups may be separate from the reporting links previously described. As an example, node 102 may be a part of an Advisory Group including HR Level L2 (node 112) and Legal level L2 (node 114). Such group membership links (116, 118, 120) may be indicated as dashed or color-coded lines, or otherwise differentiated from traditional or command reporting links, such as links 104, 108.

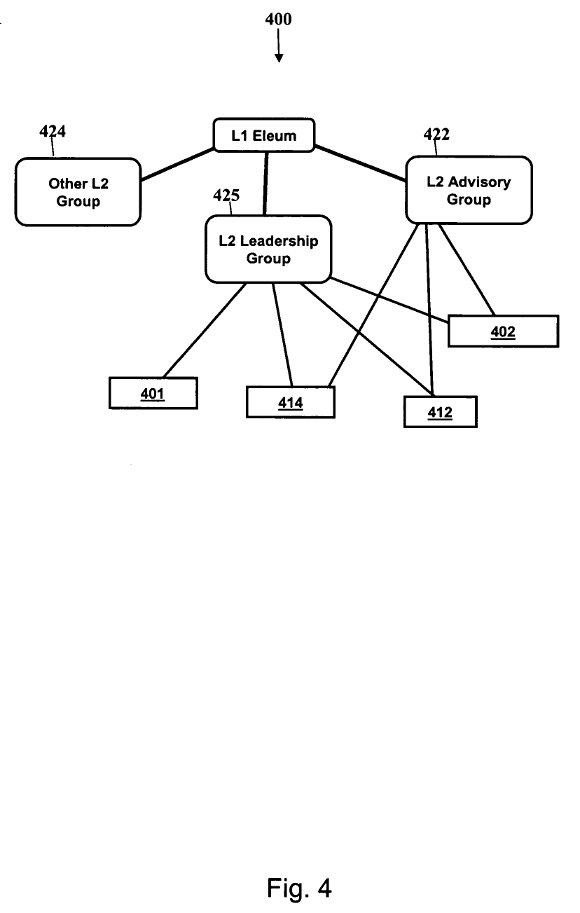

FIG. 4 illustrates a simplified network representation 400 of the organization from a group viewpoint, including the leadership team derived from a set of reporting relationships. Advisory Group 422 includes nodes 402, 412 and 414, corresponding with nodes 102, 112 and 114 in FIG. 1. A second group, Other L2 group node 424 includes other position nodes in various divisions of the organization. A third group 425 represents an L2 unit leadership group constructed by the logic of reporting relationships, including 401, 402, and 412.

Among the four types of modes, the node-as-position, or the formally defined job, may be the key to integrating the organizational network. Positions may be encoded to point to other organizational entities, e.g., they may represent a unit, be occupied (or not) by a person, and have membership in specific groups.

In addition to traditional and matrix reporting links, and membership links, functional links such as horizontal relationships among positions may be represented. For example, R&D may link (128) to Engineering (node 130), which may link (132) to Manufacturing (node 134), which may link (136) to Sales (node 138). As with traditional and matrix links, functional links may be differentiated from other types of links. For the illustrated network representation of FIG. 1, functional links 128, 132 and 136 may be indicated as dash-dot lines. It can be understood that in a colored network representation as would typically be provided to a user, both line quality and coloring may be used to differentiate amongst the types of links. In addition, personal links between positions and/or persons occupying the positions may be represented. For example, Marketing (node 140), Partnerships (node 142) and Manufacturing (134) may have social links, such as belonging to a softball league, illustrated as dash-double dot lines 144, 146, 148.

While the data for a network representation may include multitudes of links, with each group of links and/or each type of link having its own distinguishing characteristic, e.g., color, line quality, etc., the display may be configured such that the user may select which link types to display. Additionally, the network representation may allow for additional types of identification and/or color-coding schemes to be applied to the nodes and/or node links. For example, nodes may be color coded based on levels, performance ratings, profitability/non-profitability associated with a node/position, compensation associated with the node/position, and/or other data associated with a node/position.

Thus, the disclosed methods and systems may allow for a user selection of node mode, and also, of link type. One selection may include showing all link types, while another selection may include hiding all link types to allow for visualization of nodes only. One or more links of one or more link types may be associated with a given pair of nodes. Although link type is generally the same regardless of node mode, in some environments, link type may change based on node mode. For example from a positional point of view, a group may be connected by membership links, while the group itself may include a hierarchical structure with group members reporting to internal or external leaders. From a group point of view, then, the links between members may include both reporting and membership links, as well as other types of links, such as personal relationships.

Applying known network theory to a network representation of an organization, such as network representation 100, can provide useful metrics that the organization may use to analyze the structure of the organization. Within the disclosed methods and systems, in some embodiments, such metrics may be provided for analysis. In a first instance, in one embodiment, the network representation may provide an indication of hubs within the network, a hub being a node having a high, or larger than average number of links. By identifying hubs, an organization may design effective communication strategies. For example, if a hub is identified at level L5, an effective communication path for certain communications may go directly from level L1 to the level L5 hub, rather than through levels L2, L3, etc. With the level L5 hub's large number of links, the communication may be disseminated more efficiently.

In some embodiments, quantitative metrics may be determined that, when properly taken into account, can lead to more effective and efficient organizations. For a particular organization or sub-organization, a “root” node, or leadership position may be chosen and the links therefrom may be followed back to the unit positions and analyzed as a network of components. A node may have both node metrics that may be associated with the node itself, and network metrics that may be associated with the configuration of the nodes in the network representation of the organization as a while. For example, a node metric may indicate that a specific node has a specific number of links (degree) therefrom, while the associated network metric may indicate the average number of links (degree) from nodes within the network of components containing the specific node being analyzed. Using the root node framework, metrics may be provided for the network as a whole, for component networks within it, and for the nodes that populate the network. Thus, a node may have metric data specific to the node and metric data about the global characteristics of the networks encompassing the node. The network metrics can record the global effects of changes that may be made to links and nodes. For example, by adding a matrix reporting link from another node to the node being analyzed, the global path length may be significantly reduced.

A level metric may indicate the path length, or number of links to a root node, which may be used as a measure of complexity. For a given organization size, a greater number of levels means more complexity. As the number of levels increases, decision-making processes can slow down. Conversely, as the number of levels decreases, leaders or hubs can become overloaded.

The maximum path length between two nodes may be referred to as the network's diameter. The average length of the network may take into account shortcuts, or the matrix links in the organization. Path length measures may relate to speed of formal decision-making in organizations. As with hub determinations, path metrics may be used to improve communication and decision making structures.

A size metric may indicate the number of nodes in the organization or network and may provide a raw measure of information load. A simple core size may be defined from the traditional or direct reporting link that each unit-position has in the hierarchy. If a position is on a path of direct reports to a designated root node, then the position may be part of the core network. The direct reporting paths for the core network may establish a clear baseline for the organization's network, which may be of value in calculating meaningful network metrics. As functional and group relationships or links to nodes outside of the core network are added (e.g., a matrix reporting link to a position outside the root-identified core network), the scope of the network may expand from a core network to an extended network and may even extend to external nodes or positions (e.g., a functional link to a key outside partner). When applied to a particular node, the size metric may provide an indication of leadership load. As load increases, stress levels may increase and performance may suffer.

A span metric or total span metric may indicate the numbers of reporting relationships to a node (degree). A direct span metric may indicate the number of traditional or direct reporting relationships to a node. A matrix span metric may indicate the number of matrix reporting links to a node. The total span metric may be the sum of the direct and matrix span metrics. The span metric may be used to identify the hubs in the network. The direct span metric may provide a measure of command, while the matrix span metric may provide a measure of control. The total span metric can thus provide a measure of command and control. As previously described, the identification of hubs may lead to more efficient communications.

In addition to the above, further network metrics may provide increased understanding of the nature of the organizational structure and may assist in evaluating whether matrix reporting links may provide faster means of communication within the organization, or shortcuts. A degree exponent metric may indicate the shape of the plot of number of nodes against number of links per node, which may follow what is known in the art as a power law of distribution. As is known, scale-free networks include those having a few highly linked hubs and many other nodes with only a few links. The degree exponent metric may provide an indication of whether the network, or organization is scale-free, i.e., the degree to which the network representation of the organization exhibits known scale-free characteristics. At one extreme, the degree exponent metric may indicate a pattern of one hub in a population of nodes with few links. At the other extreme, the degree exponent metric may represent links randomly distributed across a population of nodes. Neither extreme indicates a desirable organizational structure. As is known in the art, a hub structure may provide robustness against accidents, but may be vulnerable to crises at the hubs, which can lead to catastrophic failure. Randomly distributed links may guard against catastrophic failure when a single node experiences a crisis, but may be prone to accidental failures.

A scale-free cutoff metric may indicate the point at which a node exceeds the maximum number of links it can maintain. While in theory, a node may have an infinite number of links, in practical applications there may be limits to how many reporting links a node or position may have within an organization. For example, these limits may include policy limits on maximum repots to a position, human capacity limits, such as when the number of subordinates a leader may effectively manage may be limited, cost limits, such as when budgetary constraints limit the growth of an organizational component, or may include combinations of these limits. Generally, these limits may be directed to direct reporting relationships. The use of a network representation including functional or matrix relationships may highlight the effects such links may have on the organizational operation.

A clustering coefficient metric may measure cohesion within the organization. This metric may signify how likely it is that positions linked to a node are themselves linked. In a strict hierarchical organization, the clustering coefficient may approach zero, as each position reports up the chain to a lead position and no lateral communication or links between positions at the same level is provided. Conversely, members of a team that tightly interact with few external connections may have a coefficient approaching one. As clustering increases, the organization or component may have difficulty with global information and decision-making. With little clustering or decreasing coefficient, local decisions and information sharing may be lost.

As described herein, the network representation of an organization may provide a visual display of the network, with content pointers and an online editing capability, an analytic engine that creates various relationship and attribute calculations and generates node and network metrics, and a “virtual workplace design” engine that translates the network into the architecture of an online workspace. As the on-line display is edited, the changes may be fed back to the database from which the original network representation was derived, including the new associations of nodes/node identifiers, links, and object information engendered by the edits.

The systems and methods described herein may serve as a framework for an online workplace or collaboration system. For example, typical objects of a collaboration system referred to generally in the art as containers, may be configured to represent separate containers for organizational units, positions, groups, people, information objects, and other types of nodes. The network representation of an organization might be directly converted into an online architecture, such as an organization-wide meeting center, where organizational elements are allocated public or private space, e.g., each organizational unit, such as Finance may have a public space, each position may have a public office, each person may have a private office, and each group a private team room. The visualization tool used for the network representation of the organization may then serve to navigate the online collaboration system.

The systems and methods described herein may serve as a category system for managing unstructured organizational knowledge, and may provide a navigation system to that knowledge. Such network representation may generally serve as a front-end to and integrator of organizational knowledge management systems. The visualization tools may serve in a simulation mode to test the effect of adding and deleting nodes and links, and of designs for organizational restructuring.

It may be understood that the methods and systems described herein are not limited to a particular hardware or software configuration, and may find applicability in many computing or processing environments. The methods and systems may be implemented in hardware or software, or a combination of hardware and software. The methods and systems may be implemented in one or more computer programs, where a computer program may be understood to include one or more processor executable instructions. The computer program(s) may execute on one or more programmable processors, and may be stored on one or more storage medium readable by the processor (including volatile and non-volatile memory and/or storage elements), one or more input devices, and/or one or more output devices. The processor thus may access one or more input devices to obtain input data, and may access one or more output devices to communicate output data. The input and/or output devices may include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) may be implemented using one or more high level procedural or object-oriented programming languages to communicate with a computer system; however, the program(s) may be implemented in assembly or machine language, if desired. The language may be compiled or interpreted.

As provided herein, the processor(s) may thus be embedded in one or more devices that may be operated independently or together in a networked environment, where the network may include, for example, a Local Area Network (LAN), wide area network (WAN), and/or may include an intranet and/or the internet and/or another network. The network(s) may be wired or wireless or a combination thereof and may use one or more communications protocols to facilitate communications between the different processors. The processors may be configured for distributed processing and may utilize, in some embodiments, a client-server model as needed. Accordingly, the methods and systems may utilize multiple processors and/or processor devices, and the processor instructions may be divided amongst such single or multiple processor/devices.

The device(s) or computer systems that integrate with the processor(s) may include, for example, a personal computer(s), workstation (e.g., Sun, HP), personal digital assistant (PDA), handheld device such as cellular telephone, laptop, handheld, or another device capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus may be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the internet. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art. Accordingly, it will be understood that the following claims are not to be limited to the embodiments disclosed herein, may include practices otherwise than specifically described, and are to be interpreted as broadly as allowed under the law.

1. A method of generating a plurality of representations of a structure for at least a portion of an organization, comprising:
assigning a plurality of positions in the organization to nodes, each position being assigned to a separate node,
defining a plurality of characteristics, each characteristic being associated with at least some positions in the organization, and having a defined value at each such associated position,
assigning each of a plurality of modes to a characteristic associated with at least some positions in the organization,
establishing a plurality of links, each link being connected to two of the nodes based on a relationship between the positions assigned to the two nodes in at least one mode, and
generating the plurality of representations, each generated representation being associated with a selected mode, wherein
each generated representation comprises a display of a network constituting a plurality of the nodes, and a plurality of the links,
each displayed node being displayed according to a value of the characteristic to which the selected mode is assigned, the value being the value of the characteristic for the position assigned to the displayed node, and
each displayed link being displayed connected to two of the displayed nodes based on the relationship between the positions assigned to the displayed nodes in the selected mode.

2. The method of claim 1, wherein each relationship is chosen from a set of relationship types including a direct reporting relationship, a matrix reporting relationship, a group membership relationship, a functional relationship, and a personal relationship.

3. The method of claim 1, further comprising determining at least one metric for the organization based on network theory analysis of the displayed network.

4. The method of claim 3, wherein determining the at least one metric comprises:
determining an average number of links per node, and
identifying hubs in the network, a hub being a node having a number of links greater than the average number of links.

5. The method of claim 4, wherein determining the average number of links comprises:
determining a first number of links based on direct reporting relationships to each node,
determining a second number of links based on matrix reporting relationships to each node,
combining the first number and second number to obtain a combined number of links to each node,
obtaining a sum of combined numbers for all nodes in the network, and
dividing the sum by a total number of nodes in the network.

6. The method of claim 3, wherein determining the at least one metric comprises:
choosing a node as a root node, and
determining an average number of links from other nodes to the root node.

7. The method of claim 3, wherein determining the at least one metric comprises determining a number of nodes in at least a portion of the network, the portion corresponding to a component of the organization.

8. A computer-readable medium containing instructions for controlling a computer system to generate a plurality of representations of a structure for at least a portion of an organization, the instructions comprising instructions for:
assigning a plurality of positions in the organization to nodes, each position being assigned to a separate node,
defining a plurality of characteristics, each characteristic being associated with at least some positions in the organization, and having a defined value at each such associated position,
assigning each of a plurality of modes to a characteristic associated with at least some positions in the organization,
establishing a plurality of links, each link being connected to two of the nodes based on a relationship between the positions assigned to the two nodes in at least one mode, and
generating the plurality of representations, each generated representation being associated with a selected mode, wherein
each generated representation comprises a display of a network constituting a plurality of the nodes, and a plurality of the links,
each displayed node being displayed according to a value of the characteristic to which the selected mode is assigned, the value being the value of the characteristic for the position assigned to the displayed node, and
each displayed link being displayed connected to two of the displayed nodes based on the relationship between the positions assigned to the displayed nodes in the selected mode.

9. The computer-readable medium of claim 8, further comprising instructions for determining at least one metric for the organization based on network theory analysis of the displayed network.
